(19) United States
(12) Patent Application Publication
(10) Pub. No.: US 2024/0151359 A1
(43) Pub. Date: May 9, 2024

(54) FUEL SYSTEMS HAVING MULTI-TANK PRESSURE-RELIEF DEVICES AND RELATED METHODS

(71) Applicant: NATURAL GAS FUEL SYSTEMS, LLC, ROANOKE, TX (US)

(72) Inventors: Michael ZIMMERMAN, Trophy Club, TX (US); Christopher CULBERSON, Denton, TX (US)

(21) Appl. No.: 18/485,092

(22) Filed: Oct. 11, 2023

Related U.S. Application Data
(60) Provisional application No. 63/415,056, filed on Oct. 11, 2022.

(51) Int. Cl. F17C 7/00; F02M 21/02

(52) U.S. Cl. CPC F17C 7/00; F02M 21/0203; F02M 21/0221; F02M 21/023; F17C 2201/0109; F17C 2205/0142; F17C 2205/0332; F17C 2205/0352; F17C 2221/012; F17C 2221/033; F17C 2223/036; F17C 2265/066; F17C 2270/0171

(57) ABSTRACT

This disclosure includes fuel systems having multi-tank pressure-relief devices and related methods. Some fuel systems have two or more fuel tanks, each containing fuel at a pressure at or above 3,000 pounds per square inch (“psi”), two or more pressure-relief devices (“PRDs”) configured to receive fuel from the fuel tanks and vent the received fuel in response to temperature, and fuel conduits coupling the fuel tanks to the PRDs such that, for each of the fuel tanks, for each of the PRDs, fuel is permitted to flow from the fuel tank to the PRD without flowing through a valve that is not one of the PRDs.

### CROSS-REFERENCE TO RELATED APPLICATIONS

The present invention application claims the benefit of priority to U.S. Provisional Patent Application No. 63/415,056, filed Oct. 11, 2022, the entire contents of which are hereby incorporated by reference.

### FIELD OF INVENTION

The present invention relates generally to fuel systems and, more specifically but not by way of limitation, to fuel systems having fuel tanks and pressure relief devices (“PRDs”), where each of the PRDs is in fluid communication with each of the fuel tanks, which—amongst other benefits—may facilitate a reduction in the number of conduits, connectors, or (e.g., non-PRD) valves in the fuel system, by, for example, eliminating the need for separate PRD plumbing and tank valve plumbing.

### BACKGROUND

Some vehicles, such as compressed natural gas (“CNG”) vehicles, include a fuel system having fuel tanks as well as valves for controlling the flow of fuel from those fuel tanks. Such valves can include, for example, PRDs that vent fuel from the fuel system in the event of excessive heat in the fuel system, shut-off valves that block fluid communication from portions of the fuel system (e.g., from one or more of the fuel tanks), and/or the like. Connecting those valves in fluid communication with the fuel tanks is often achieved via additional conduits, connectors, and/or valves, such as other (e.g., tank-fitting-mounted) shut-off valves or PRDs, directional control valves, and/or the like. These additional conduits, connectors, and valves, however, introduce complexity to the fuel system as well as the potential for fuel system failures and leaks.

Such fuel systems are also often configured such that a valve (e.g., a PRD and/or a shut-off valve) is in control of fuel flow from less than all of the fuel tanks. To illustrate, there can be a shut-off valve and/or PRD that controls fuel flow from an individual one of the fuel tanks. But this sort of configuration has disadvantages. For instance, if a shut-off valve or PRD fails to operate properly, fuel flow from its associated fuel tank(s) may not cease or vent, respectively, creating a risk of a fire or explosion, even if another shut-off valve or PRD associated with other fuel tank(s) operates properly.

### SUMMARY

Some of the present fuel systems can address these issues by facilitating fuel flow between fuel tanks and a valve—such as a PRD, shut-off valve, and/or the like—in a fuel system at a reduced or eliminated need for additional conduits, connectors, or valves, thereby reducing complexity and promoting reliability, as well as facilitating control of fuel flow from multiple—up to an including all—of the fuel system's fuel tanks via each of a single set of one or more PRDs and/or each of a single set of one or more shut-off valves, thereby promoting safety. In some of the present fuel systems, a reduction in conduits, connectors, or valves can be achieved via each of the fuel system's fuel tanks being controlled by a single set of one or more PRDs and a single set of one or more shut-off valves, thereby facilitating use of the same plumbing for both PRD and shut-off valve purposes. When the single set of PRDs includes multiple PRDs, a further advantage can be realized: the PRDs can be positioned in the fuel system that they are responsive to events (e.g., fires) at various locations in or around the fuel system.

The above benefits can be achieved via, for example, the fluid-communication connections between fuel tanks and PRDs, shut-off valves, and/or the like described herein, which can optionally be facilitated by the present fuel tank fittings. To illustrate, one of the present fuel tank fittings can be sealingly attached to a first fuel tank and can include a first port that permits fuel flow between the first fuel tank and a second fuel tank without flowing through a valve, and a second port that permits fuel flow from the first and second fuel tanks to a valve (e.g., a PRD, shut-off valve, and/or the like).

Some of the present fuel tank fittings can receive a plug that facilitates testing and/or commissioning of an individual (or an individual set of) fuel system components, such as the tank to which the fitting is attached, fuel lines that connect to the fitting, and/or the like. To illustrate, the plug can be received by the fuel tank fitting such that fluid is not permitted to flow from the fuel tank and through ports of the fitting for connecting to other fuel tanks or valves (e.g., the first and second ports described above) or vice versa, in some instances, without preventing fluid flow between such ports through the fitting. In this way, for example, the fuel tank can be isolated from fuel lines connected to the fitting, facilitating pressure testing of the fuel lines without requiring pressurization of the fuel tank. Some such plugs can include an interior passageway that is in fluid communication with the fuel tank to ensure that the fuel tank does not become pressurized during pressure testing of the fuel lines, as well as to allow, for example, testing and/or commissioning of the fuel tank.

Some of the present fuel tank fittings comprise: a first end including a connector configured to be coupled to an outlet of a fuel tank such that the connector is sealingly received by the outlet or sealingly receives the outlet, wherein the connector has a connection axis, a second end including two or more first ports, each positioned such that the connection axis does not extend therethrough, a first interior passageway extending from the connector, and two or more second interior passageways connecting the first interior passageway to the first ports such that, for each of the first ports, fluid is permitted to flow from the connector, through the first interior passageway, through one or more of the second interior passageways, and out of the first port without flowing through a valve, wherein the fitting has a burst pressure that is between 10,000 pounds per square inch (“psi”) and 36,000 psi. In some fuel tank fittings, the connector is configured to be coupled to the outlet by rotating at least a portion of the connector relative to the outlet about the connection axis.

In some fuel tank fittings, the first ports comprise four ports. In some fuel tank fittings, each of the second interior passageways has a centerline that is angularly disposed by an angle of approximately 90 degrees relative to the connection axis.

In some fuel tank fittings, the second end of the fitting includes a second port, the first interior passageway extends to the second port such that fluid is permitted to flow from the connector, through the first interior passageway, and out of the second port without flowing through a valve, and the first interior passageway includes a first portion that is upstream of each of the second interior passageways, and a second portion that is downstream of each of the second interior passageways. In some fuel tank fittings, a centerline of the first portion is aligned with a centerline of the second portion, and, optionally, the centerline of the first portion is aligned with the connection axis.

Some of the present systems comprise one of the present fuel tank fittings and a plug configured to be received through the second port and into the first interior passageway such that the plug sealingly engages the second port and/or the second portion of the first interior passageway and the connector and/or the first portion of the first interior passageway, wherein, when the plug is received by the first interior passageway, fluid is permitted to flow from at least one of the second interior passageways, past the plug, and to at least one other of the second interior passageways.

Some of the present fuel systems comprise: two or more fuel tanks and one or more fuel tank fittings, each coupled to an outlet of a respective one of the fuel tanks and including two or more first ports, wherein, for at least one of the first ports, fluid is permitted to flow from the fuel tank, through the fuel tank fitting, out of the first port, and into at least one other of the fuel tanks without flowing through a valve. In some fuel systems, for at least one of the fuel tank fitting(s), for each of the first ports, fluid is permitted to flow from the fuel tank, through the fuel tank fitting, out of the first port, and into at least one other of the fuel tanks without flowing through a valve and without flowing back through the fuel tank fitting.

In some fuel systems, at least one of the fuel tank fitting(s) includes a second port, and the system comprises a plug that is received by the second port such that fluid from the respective one of the fuel tanks is prevented from flowing out of the first ports, and fluid is permitted to flow into at least one of the first ports, through the fitting, and out of at least one other of the first ports.

Some fuel systems comprise a valve in fluid communication with each of the fuel tanks. In some fuel systems, the valve comprises a PRD. In some fuel systems, the valve comprises a shut-off valve configured to prevent fluid communication between the fuel tanks and an engine.

In some fuel systems, pressure within each of the fuel tank fitting(s) is between 3,000 psi and 12,000 psi (e.g., between 3,000 psi and 4,500 psi with CNG as the fuel, and up to 12,000 psi if the fuel is hydrogen). In some fuel systems, each of the fuel tank fitting(s) has a burst pressure that is between 10,000 psi and 36,000 psi.

Some of the present methods of providing CNG to an engine comprise: flowing CNG from a first fuel tank and from a second fuel tank through a fuel tank fitting connected to the second fuel tank without flowing the CNG through a valve, and flowing the CNG to the engine. In some methods, when flowed through the fuel tank fitting, the CNG is at a pressure of between 3,000 psi and 4,500 psi. Some methods comprise, before flowing the CNG to the engine, flowing the CNG through a shut-off valve. Some methods comprise flowing the CNG through a PRD.

Some methods comprise inserting a plug into the fuel tank fitting such that fluid is prevented from flowing from the second fuel tank and through the fuel tank fitting and fluid is permitted to flow from the first fuel tank and through the fuel tank fitting.

Some of the present fuel systems comprise: two or more fuel tanks, each containing fuel at a pressure of between 3,000 psi and 12,000 psi, two or more PRDs configured to receive fuel from the fuel tanks and vent the received fuel in response to temperature, and fuel conduits coupling the fuel tanks to the PRDs such that, for each of the fuel tanks, for each of the PRDs, fuel is permitted to flow from the fuel tank to the PRD without flowing through a valve that is not one of the PRDs. In some fuel systems, the fuel conduits couple the fuel tanks to the PRDs such that, for each of the fuel tanks, for at least one of the PRDs, fuel is permitted to flow from the fuel tank to the PRD without flowing through another one of the PRDs. In some fuel systems, the fuel tanks comprise three or more fuel tanks. In some fuel systems, the PRDs comprise four or more PRDs.

In some fuel systems, each of the fuel tanks comprises an outlet through which fuel is permitted to exit the fuel tank, and none of the PRDs are mounted to the outlet of any of the fuel tanks.

In some fuel systems, at least one of the PRDs is configured to vent the received fuel upon reaching a temperature that is between approximately 100° C. and approximately 120° C. Some fuel systems comprise a vent tube configured to receive fuel that is vented by at least one of the PRDs. In some fuel systems, the fuel comprises CNG.

In some fuel systems, the fuel system is installed on a vehicle having an engine and comprises a shut-off valve configured to control the flow of fuel from the fuel tanks to the engine, and the fuel conduits couple the fuel tanks to the shut-off valve such that, for each of the fuel tanks, fuel is permitted to flow from the fuel tank to the shut-off valve without flowing through a valve that is not one of the PRDs.

Some of the present methods comprise flowing fuel from two or more fuel tanks of a vehicle to two or more PRDs of the vehicle that are configured to vent the fuel in response to temperature, wherein the fuel tanks are coupled in fluid communication with the PRDs such that, for each of the fuel tanks, for each of the PRDs, fuel is permitted to flow from the fuel tank to the PRD without flowing through a valve that is not one of the PRDs, and wherein the fuel is at a pressure that is between 3,000 psi and 12,000 psi. In some methods, the fuel tanks are coupled in fluid communication with the PRDs such that, for each of the fuel tanks, for at least one of the PRDs, fuel is permitted to flow from the fuel tank to the PRD without flowing through another one of the PRDs. In some methods, the fuel tanks comprise three or more fuel tanks. In some methods, the PRDs comprise four or more PRDs.

In some methods, each of the fuel tanks comprises an outlet through which fuel exits the fuel tank, and none of the PRDs are mounted to the outlet of any of the fuel tanks.

In some methods, at least one of the PRDs is configured to vent the fuel upon reaching a temperature that is between approximately 100° C. and approximately 120° C. In some methods, the vehicle comprises a vent tube configured to receive fuel that is vented by at least one of the PRDs. In some methods, the fuel comprises CNG.

In some methods, the vehicle comprises an engine and a shut-off valve configured to control the flow of fuel from the fuel tanks to the engine, and the fuel tanks are coupled in fluid communication with the shut-off valve such that, for each of the fuel tanks, fuel is permitted to flow from the fuel tank to the shut-off valve without flowing through a valve that is not one of the PRDs.

The term “coupled” is defined as connected, although not necessarily directly, and not necessarily mechanically; two items that are “coupled” may be unitary with each other. The terms “a” and “an” are defined as one or more unless this disclosure explicitly requires otherwise. In any disclosed embodiment, the terms “approximately” and “substantially” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including,” are open-ended linking verbs. As a result, an apparatus that “comprises,” “has,” or “includes” one or more elements possesses those one or more elements but is not limited to possessing only those one or more elements. Likewise, a method that “comprises,” “has,” or “includes” one or more steps possesses those one or more steps but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above in order to change the scope of the claim from what it would otherwise be using the open-ended linking verb.

Further, a device or system that is configured in a certain way is configured in at least that way, but it can also be configured in ways other than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Excepting those identified as schematics, the figures are drawn to scale, meaning the sizes of the depicted elements in each are accurate relative to each other for at least the embodiment shown.

FIG. 1A is a perspective view of one of the present fuel tank fittings.

FIG. 1B is a side view of the fuel tank fitting of FIG. 1A.

FIG. 1C is a back view of the fuel tank fitting of FIG. 1A and shows a first end of the fuel tank fitting including a connector for coupling to a tank.

FIG. 1D is a front view of the fuel tank fitting of FIG. 1A and shows a second end of the fuel tank fitting that includes first ports.

FIG. 1E is a cross-sectional perspective view of the fuel tank fitting of FIG. 1A, showing a connection axis of the connector at the first end and the first ports at the second end, each of the first ports positioned such that the connection axis does not extend therethrough.

FIG. 1F is a cross-sectional front view of the fuel tank fitting of FIG. 1A, showing the first ports.

FIG. 2A is a perspective view of a plug that is configured to be received by a second port of the fuel tank fitting of FIG. 1A.

FIG. 2B is a cross-sectional perspective view of the plug of FIG. 2A.

FIG. 2C is a side view of the plug of FIG. 2A.

FIG. 3 is a cross-sectional side view of the fuel tank fitting of FIG. 1A assembled with the plug of FIG. 2A.

FIG. 4 is a schematic of a fuel system that includes ones of the present fuel tank fittings disposed in fluid communication between fuel tanks and valves of the fuel system.

FIG. 5 is a schematic of a PRD that is suitable for use in the present fuel systems.

FIG. 6A is a schematic of one of the present vehicles that includes a fuel system like that of FIG. 4.

FIG. 6B is a schematic of the fuel system and related components of the vehicle of FIG. 6A.

FIG. 7 is a schematic of one of the present fueling stations that includes ones of the present fuel tank fittings disposed in fluid communication between fuel tanks and nozzles of the fueling station.

FIG. 8 is a schematic of one of the present fuel systems that includes fuel tanks and PRDs, where each of the PRDs is in fluid communication with each of the fuel tanks without any non-PRD valves disposed in fluid communication between the fuel tank and the PRD.

### DETAILED DESCRIPTION

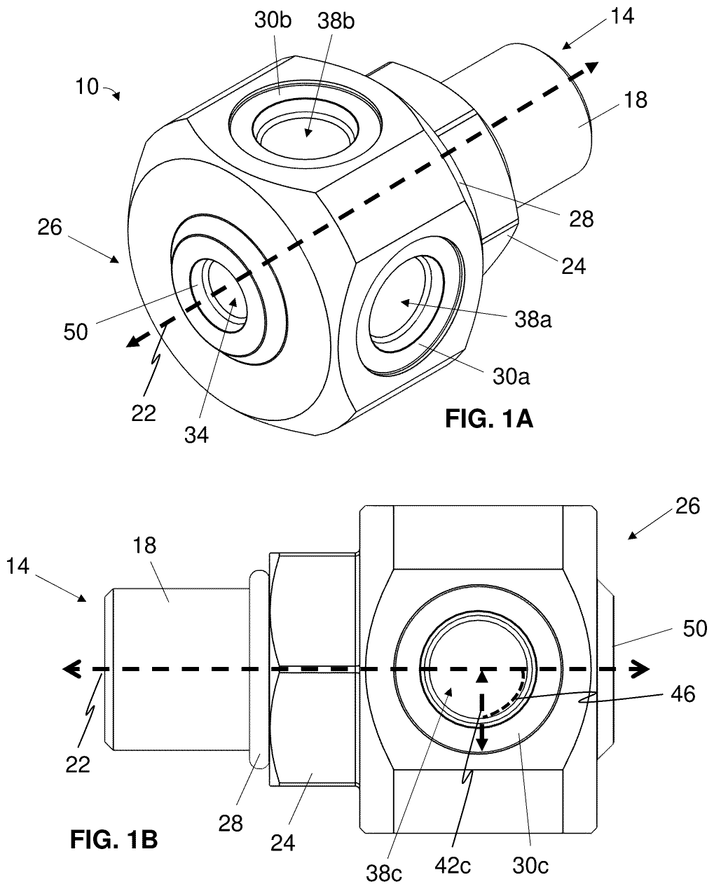

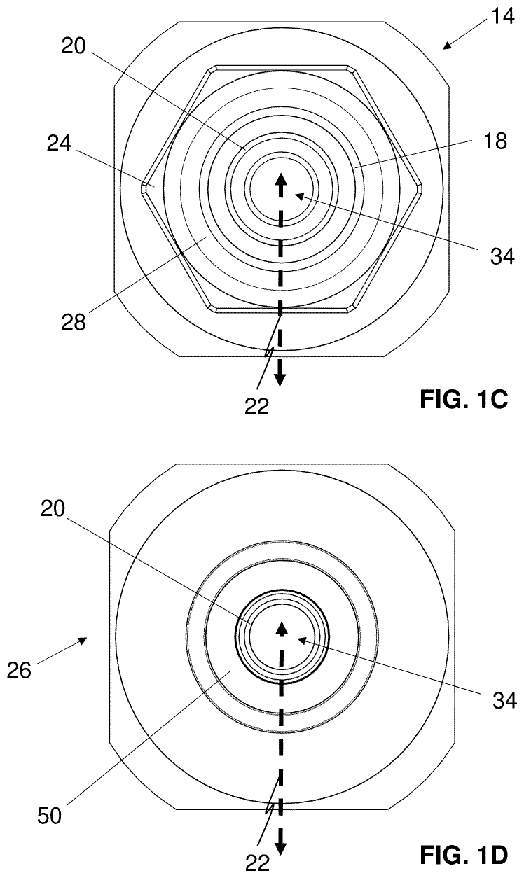

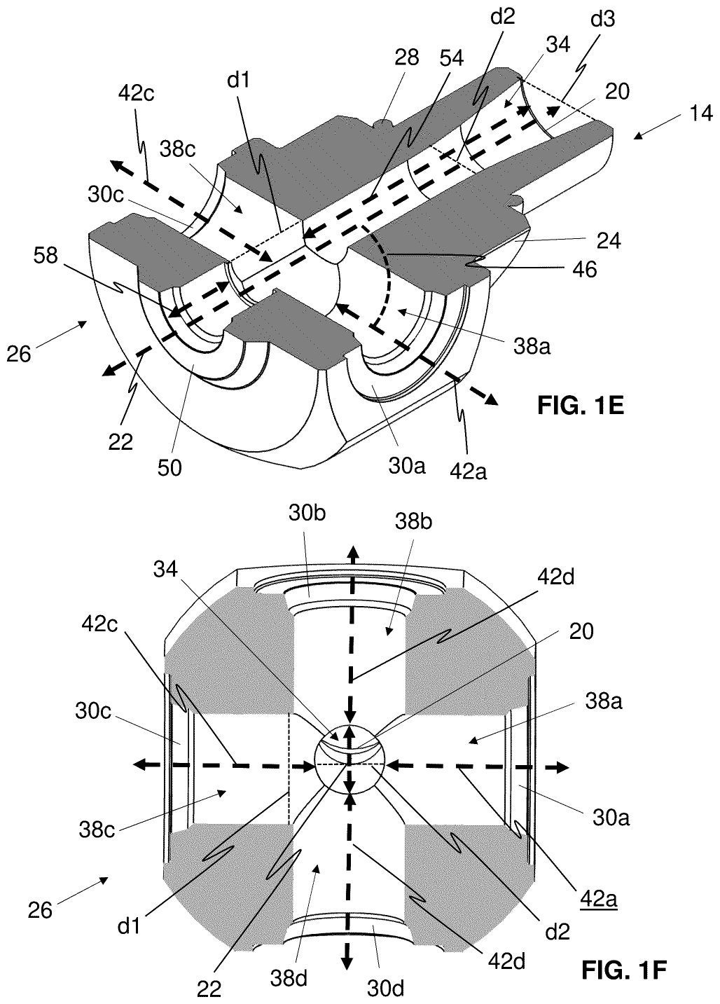

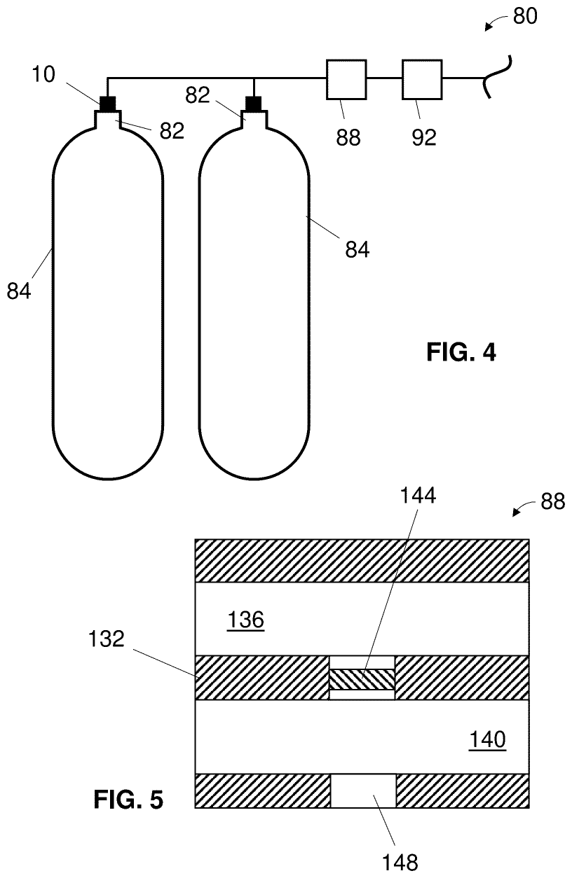

Referring now to the drawings, FIGS. 1A-1F depict a first embodiment 10 of the present fuel tank fittings. As shown in FIGS. 1A-1C and 1E, fuel tank fitting 10 can include a first end 14 defining a connector 18. Connector 18 can define an inlet 20 of fuel tank fitting 10. Connector 18 can be configured to be coupled to an outlet (e.g., a neck) of a fuel tank (e.g., outlet 82 of fuel tank 84, FIG. 4) through which fuel is permitted to exit the fuel tank. Connector 18 can be sealingly received by the fuel tank's outlet, or alternatively, the connector can sealingly receive the fuel tank's outlet. Sealing reception of connector 18 by the outlet or sealing reception of the outlet by the connector can be fluid-tight such that fuel (e.g., CNG or hydrogen) from the fuel tank is prevented from escaping via the connector/fuel tank interface.

Connector 18 can have a connection axis 22 around which at least a portion of the connector is rotated relative to the outlet to couple the connector to the outlet. For example, connector 18 can have external threads or internal threads that mate with corresponding internal threads or external threads, respectively, on the outlet. Such threads can be configured to form a seal when mated, whether with the assistance of a gasket 28 (e.g., an O-ring), sealant (e.g., Teflon tape, a jointing compound, and/or the like), and/or the like, or without such assistance. To facilitate such mating, connector 18 can include a surface that interfaces with a tool during installation of the connector onto the outlet, such as, for example, the depicted hexagonal surface 24 (akin to a nut) that is receivable by a conventional wrench.

Fuel tank fitting 10 can also include a second end 26 defining two or more (e.g., 2, 3, 4, 5, or more) first ports. For example, in the embodiment shown, second end 26 includes four first ports 30a, 30b, 30c, and 30d. As shown in FIGS. 1E and 1F, the first ports can each be positioned such that connection axis 22 of connector 18 does not extend therethrough. Rather, as depicted in FIGS. 1E and 1F, connector 18 can be coupled in fluid communication with the first ports via a first interior passageway 34 that extends from inlet 20 and is in fluid communication with two or more second interior passageways (described below) extending between the first interior passageway and the first ports. Referring to FIG. 1E, first interior passageway 34 can include a first portion 54 upstream of each of the second interior passageways and a second portion 58 that is downstream of each of the second interior passageways. A centerline of first portion 54 of first interior passageway 34 can be substantially aligned with a centerline of second portion 58 of the first interior passageway to facilitate operation of plug 60 (described below). And the centerline of first portion 54 of first interior passageway 34 can be substantially aligned with connection axis 22 of connector 18.

As further shown in FIGS. 1E and 1F, each of first ports 30a, 30b, 30c, and 30d is in fluid communication with a respective one of second interior passageways 38a, 38b, 38c, and 38d. Each of the second interior passageways can have a centerline (42a-42d) that is angularly disposed at an angle 46 relative to connection axis 22 of connector 18. To illustrate, for each of those centerlines, angle 46 can be approximately equal to any one of, or between any two of: 45, 50, 55, 60, 65, 70, 75, 80, 85, 90, 95, 100, 105, 110, 115, 120, 125, 130, and 135 degrees (e.g., approximately 90 degrees). Each of the second interior passageways can have a minimum transverse dimension d1 that is greater than a minimum transverse dimension d2 of first interior passageway 34. To illustrate, d2 can be less than or approximately equal to any one of, or between any two of: 30, 35, 40, 45, 50, 55, 60, 65, 70, 75, 80, 85, or 95% (e.g., approximately 65%) of d1. Also, the transverse dimension of first interior passageway 34 can taper along the first interior passageway. To illustrate, at inlet 20, first interior passageway 34 can have an (e.g., maximum, as shown) transverse dimension d3, and the transverse dimension can taper along the first interior passageway in a direction toward second end 26 (e.g., to its minimum transverse dimension d2). Transverse dimension d2 can be, for example, less than or approximately equal to any one of, or between any two of: 30, 35, 40, 45, 50, 55, 60, 65, 70, 75, 80, 85, or 95% (e.g., approximately 65%) of d3.

With the second interior passageways connecting first interior passageway 34 to the first ports, fluid can flow from connector 18, through the first interior passageway, through one or more of the second interior passageways, and out of one or more of the first ports. And as shown, such fluid flow can be achieved without the fluid flowing through a valve. In at least that way, the present fuel tank fittings can reduce the complexity of a fuel system (e.g., 100, discussed below) incorporating the same as well as the potential for fuel system failures and leaks.

Second end 26 of fuel tank fitting 10 can also include a second port 50. First interior passageway 34 can extend from connector 18 to second port 50 such that fluid can flow from the connector, through the first interior passageway, and out of the second port. As shown, fluid is permitted to flow from connector 18 and out of second port 50 without flowing through a valve.

Fitting 10 can have a burst pressure that is 10,000 psi or greater. For example, the fitting can have a burst pressure that is greater than or equal to any one of, or between any two of: 10,000, 10,500, 11,000, 11,500, 12,000, 12,500, 13,000, 13,500, 14,000, 14,500, 15,000, 15,500, 16,000, 16,500, 17,000, 17,500, 18,000, 18,500, 19,000, 19,500, 20,000, or 25,000, 30,000, or 35,000 psi (e.g., between 10,000 psi and 36,000 psi). And when in normal use, pressure within fitting 10 can be 3,000 psi or greater. For example, pressure within the fitting can be greater than or equal to any one of, or between any two of: 3,000, 3,500, 4,000, 4,500, 5,000, 5,500, 6,000, 6,500, 7,000, 7,500, 8,000, 9,000, 10,000, 11,000 or 12,000 psi, which in some instances, depends on the type of fuel that the fitting is used with. To illustrate, if the fuel is CNG, pressure within the fitting can be between 3,000 and 4,500 psi, and if the fuel is hydrogen, pressure within the fitting can be higher (e.g., up to 12,000 psi or higher). Of course, pressure within the fitting can be below 3,000 psi, down to and including 0 psi, such as when the fitting's fuel system is empty.

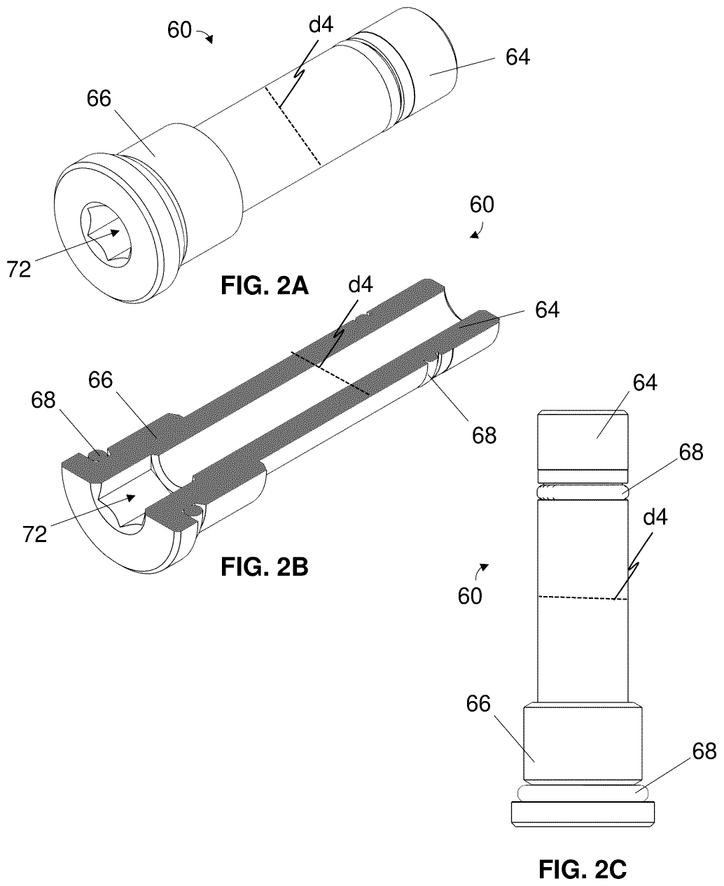

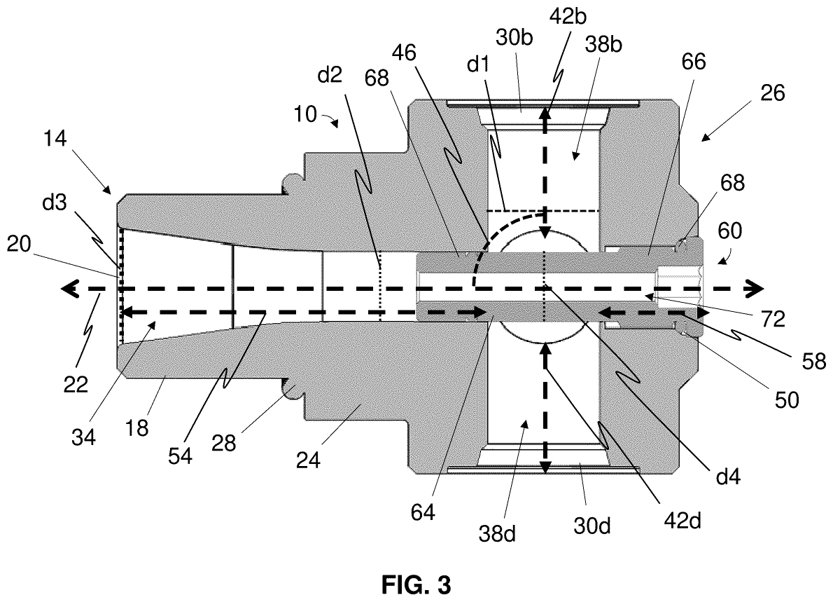

Referring additionally to FIGS. 2A-3, fuel tank fitting 10 can be included in a system with a plug 60. Plug 60 can be configured to be received through second port 50 of fuel tank fitting 10 and into first interior passageway 34 of the fitting. For example, as shown in FIG. 3, a body 64 of plug 60 can be inserted through second port 50 of fitting 10 and into first interior passageway 34 of the fitting.

When received through second port 50, plug 60 can sealingly engage the second port and/or second portion 58 of first interior passageway 34 that is downstream of each of the second interior passageways (e.g., at a coupling end 66 of the plug, via an O-ring 68). Plug 60 can also sealingly engage connector 18 and/or first portion 54 of the first interior passageway that is upstream of each of the second interior passageways (e.g., at body 64 of the plug, via an O-ring 68). Thus, in some aspects, plug 60 sealingly engages second port 50 and/or second portion 58 of first interior passageway 34 as well as connector 18 and/or first portion 54 of the first interior passageway. Sealing engagement of second port 50, second portion 58 of first interior passageway 34, connector 18, and/or first portion 54 of the first interior passageway by plug 60 can be fluid-tight similarly to as described above.

When plug 60 is received by first interior passageway 34 of fuel tank fitting 10, fluid is permitted to flow from at least one of the second interior passageways, past the plug, and to at least one other of the second interior passageways of the fuel tank fitting. Such flow can be facilitated, at least in part, due to a transverse dimension (e.g., d4) of a portion of plug 60 being smaller than a transverse dimension (e.g., d1) of the second interior passageways where the same meet.

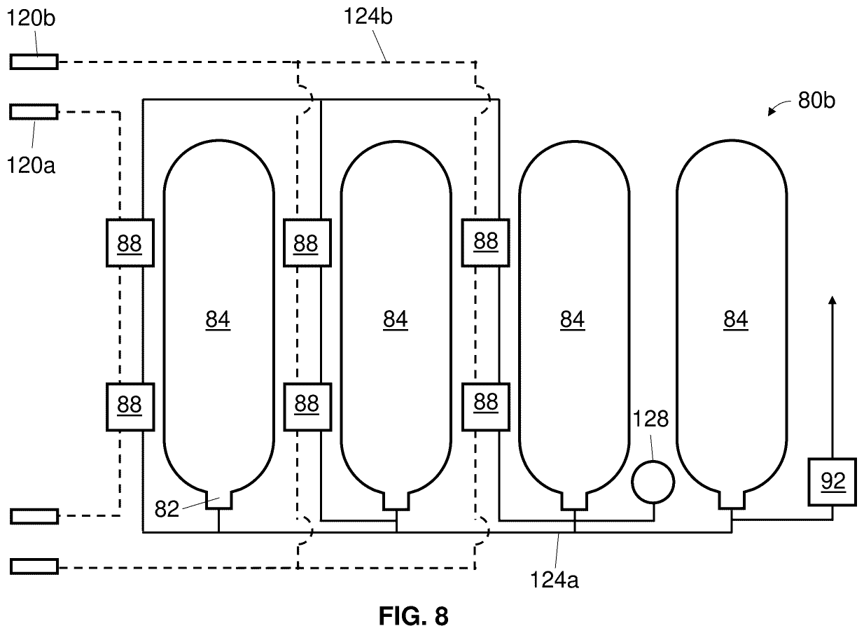

Plug 60 can also define a plug interior passageway 72. Plug interior passageway 72 can permit fluid to flow from connector 18, through the plug interior passageway, and out of second port 50 of fuel tank fitting 10. In some aspects, plug interior passageway 72 can facilitate testing of conduits (e.g., 124a, FIG. 8) coupled to fuel tank fitting 10. To illustrate, when such conduits are pressurized, even if either of plug 60's O-rings 68 fails, the tank will not become pressurized, and—in the event of the plug's tank-side O-ring 68 failing—any fuel leaking from the tank can be detected through the interior passageway. In this and other aspects, plug interior passageway 72 can also advantageously permit isolation of a fuel tank coupled to fuel tank fitting 10 for testing and/or commissioning.

Referring now to FIG. 4, shown is a fuel system 80 incorporating the present fuel tank fittings. As shown, fuel system 80 can include two or more (e.g., 2, 3, 4, 5, or more) fuel tanks 84 for storing pressurized fuel, such as, for example, CNG or hydrogen, and one or more (e.g., 1, 2, 3, 4, 5, or more) fuel tank fittings (e.g., 10). Each of the fuel tank fittings can be coupled to an outlet 82 of one of fuel tanks 84. To illustrate, fuel system 80 includes two fuel tanks 84, each having one of fittings 10 coupled to its outlet 82.

Each of the fuel tank fittings can include two or more first ports (e.g., 30a-30d), and fluid can flow from a first one of fuel tanks 84, through a first one of the fittings that is coupled to the first fuel tank (e.g., from its connector 18, through its first interior passageway 34, and through one or more of its second interior passageways 38), out of one of the first ports of the first fitting, through a second one of the fittings, and into a second one of the fuel tanks to which the second fitting is coupled. In some aspects, fluid is permitted to flow from the first fuel tank and out of the first port of the first fitting (e.g., and into the second fuel tank) without flowing through a valve. And in some aspects, fluid is permitted to flow from the first fuel tank and out of the first port of the first fitting (e.g., and into the second fuel tank) without flowing back through the first fitting.

In some aspects, at least one of the fuel tank fittings of fuel system 80 includes a second port (e.g., 50), and the second port receives a plug (e.g., 60) as described above. For each such fuel tank fitting, when the plug is received by the second port, fluid from the fitting's fuel tank 84 is prevented from flowing out of the fuel tank fitting's first ports, in some instances, while permitting fluid (e.g., from another of fuel tanks 84) to flow into at least one of the first ports, through the fuel tank fitting, and out of at least one other of the first ports.

Fuel system 80 can also have one or more valves (e.g., 88, 92) in fluid communication with each of fuel tanks 84. Such valve(s) can include, for example, one or more PRDs (e.g., 88) for venting fuel from fuel tanks 84 and preventing rupture of fuel system 80 components in the event of excessive temperature in the fuel system. To illustrate, such a PRD can be configured to vent fuel received by the PRD upon reaching a temperature that is greater than or approximately equal to any one of, or between any two of: 80, 90, 100, 110, 120, 130, and 140° C., such as a temperature of from approximately 100° C. to approximately 120° C.

An illustrative PRD 88 is shown in FIG. 5. As depicted, PRD 88 can include a body 132 that defines a fuel channel 136 as well as a vent channel 140. Fuel channel 136 can be in fluid communication with each of fuel tanks 84 (e.g., via conduits 124a, described below), and vent channel 136 can be in fluid communication with a vent, whether defined by body 132 (e.g., vent 148, as shown) or not (e.g., vents 120a and/or 120b, described below). During normal operation, PRD includes a heat-defeatable barrier 144 that prevents fluid communication between fuel channel 136 and vent channel 140. And when PRD 88—specifically, heat-defeatable barrier 144—reaches a predetermined temperature, the heat-defeatable barrier can fail, permitting fuel in fuel channel 136 (and thus from each of fuel tanks 84) to flow into vent channel 140 from which it is vented (e.g., via vent 148). Heat-defeatable barrier 144 can comprise, for example, a eutectic material. As used here in, fuel that flows “through” a PRD need not be vented by that PRD. To illustrate, fuel that flows through PRD 88's fuel channel 136 flows “through” PRD 88, even if that fuel does not enter vent channel 140.

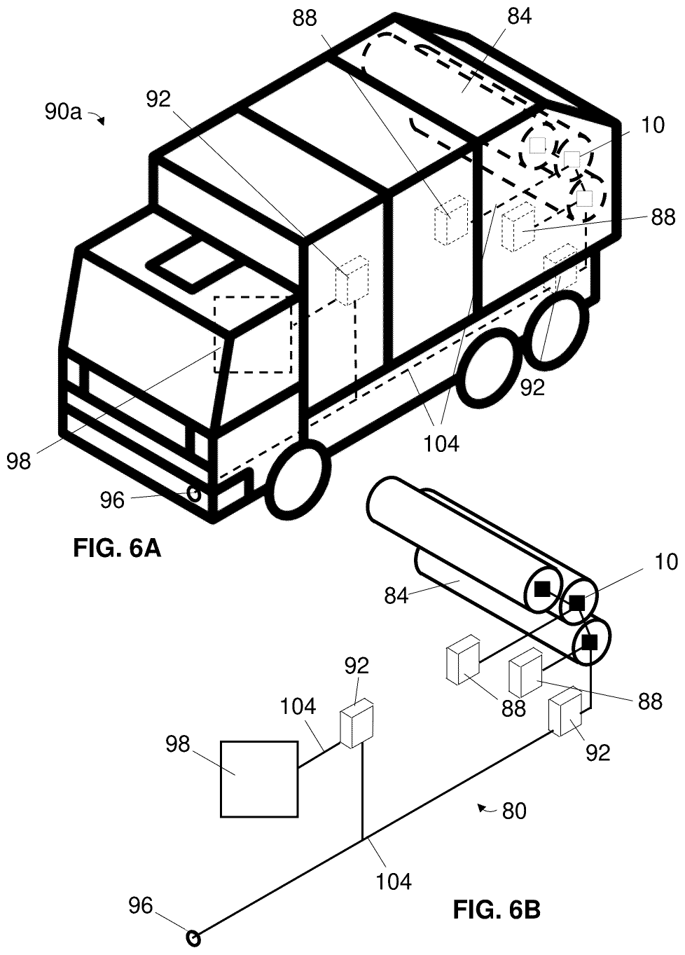

The valve(s) can additionally or alternatively include one or more shut-off valves (e.g., 92) configured to prevent fluid communication between fuel tanks 84 and an engine (e.g., 98) and/or a fill port (e.g., 96) of a vehicle (e.g., 90a, FIGS. 6A and 6B). Particularly in fuel systems (e.g., 80) in which the valve(s) include multiple types of valves (e.g., one or more PRDs 88 and one or more shut-off valves 92), a reduction in conduits, connectors, and/or valves can be realized. To illustrate, plumbing for PRD(s) 88 can also be used as plumbing for shut-off valve(s) 92. Of course, fluid flow from a fuel tank fitting (e.g., 10), such as from one of its first ports (e.g., 30a-30d), can be directed to any of the valves described above, an engine (e.g., 98), a pressure gauge (e.g., 128, FIG. 8), and/or the like.

FIGS. 6A and 6B illustrate use of a fuel system including one or more of the present fuel tank fittings (e.g., 10) in a vehicle 90a. Vehicle 90a can include a fuel system having fuel tanks 84 for storing pressurized fuel, such as, for example, CNG or hydrogen. Vehicle 90a can also include a fill port 96 for receiving pressurized fuel for storage in fuel tanks 84.

In some aspects, vehicle 90a's fuel system includes one or more valves, such as the PRDs and/or shut-off valves as described above. To illustrate, the depicted fuel system includes two PRDs 88 for venting fuel from fuel tanks 84 in the event of excessive temperature in the fuel system, and two shut-off valves 92: one to prevent fluid communication between the fuel tanks and an engine 98, and one to prevent fluid communication between a fill port 96 and the fuel tanks. A shut-off valve 92 can be disposed in fluid communication between fill port 96 and the fittings coupled to the outlets of fuel tanks 84 such that, to flow from the fill port to the fuel tanks via a fuel line 104, fuel must first flow through the shut-off valve, but fuel can nevertheless be permitted to flow from a first port of one of the fittings coupled to a first one of the fuel tanks to at least a first port of one of the fittings coupled to a second one of the fuel tanks (e.g., between ones of the fuel tanks) without flowing through a valve.

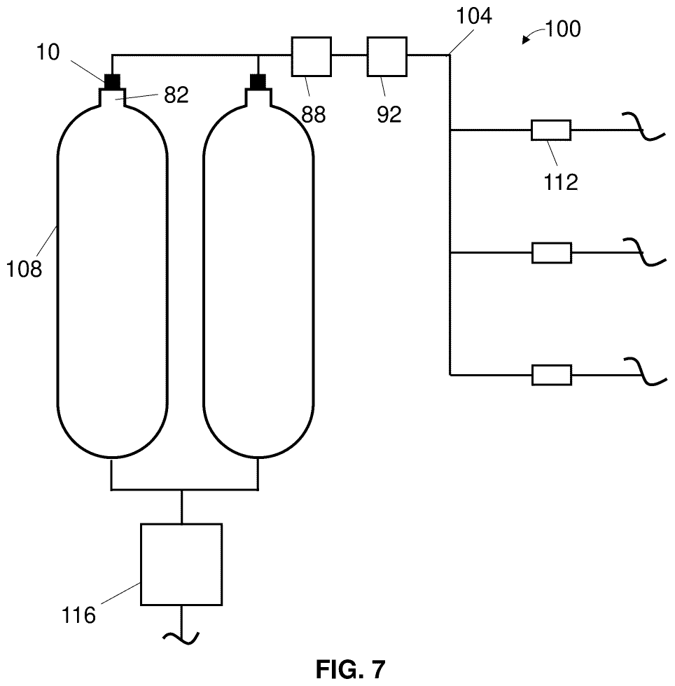

Turning now to FIG. 7, another illustrative use of the present fuel tank fittings is in a fueling station, such as fueling station 100. Fueling station 100 can include one or more tanks 108 configured to store fuel, one or more nozzles 112 configured to receive fuel from the tanks to provide that fuel to one or more vehicles, and one or more fuel tank fittings (e.g., 10), each disposed in fluid communication between at least one of the tanks and at least one of the nozzles such that, to flow from the tank to the nozzle, fuel flows through the fitting.

As shown, fueling station 100 can also include a compressor 116 disposed upstream of nozzle(s) 112, whether upstream (as shown) or downstream of tank(s) 108, that pressurizes fuel before its receipt by the nozzle(s). And fueling station 100 can include one or more valves (e.g., 88, 92) each disposed in fluid communication between tanks 108 and nozzles 112 such that, to flow from the tanks to the nozzles, fuel flows through the valve(s). The valve(s) of fueling station 100 can include PRDs and/or shut-off valves as described above.

Some of the present methods comprise fueling a vehicle (e.g., 90a) with one of the present fueling stations (e.g., 100) at least by connecting a nozzle (e.g., one of nozzle(s) 112) to a fill port (e.g., 96) of the vehicle and directing fuel from one or more tanks (e.g., 108) of the fueling station through at least one of the present fuel tank fittings (e.g., 10) and into the fill port.

Referring now to FIG. 8, shown is another embodiment 80b of the present fuel systems. Fuel system 80b includes four fuel tanks 84. Otherwise similar embodiments of the present fuel systems, however, can include any suitable number of fuel tanks, such as, for example, 2, 3, 5, 6, or more fuel tanks. Fuel system 80b can be configured to store pressurized fuel. To illustrate, fuel tanks 84 can contain fuel that is at a pressure that is between 3,000 psi and 12,000 psi. Examples of pressurized fuels usable with fuel system 80b include CNG, hydrogen, and the like. Accordingly, fuel system 80b includes PRDs 88 to mitigate the risk of fuel system rupture, fire, explosion, and the like. To illustrate, fuel system 80b includes six PRDs 88, but otherwise similar embodiments of the present systems can include any suitable number of PRDs, such as, for example, 2, 3, 4, 5, 7, or more PRDs.

To direct fuel vented by PRDs 88 away from fuel system 80b, the fuel system can include one or more vent tubes (e.g., 120a and 120b) configured (e.g., via conduits 124b) to receive fuel that is vented by the PRDs. And at least one of—up to including each of—the vent tubes can be configured to receive fuel that is vented by at least one of—up to and including each of—the PRDs. To illustrate, in fuel system 80b vent tubes 120a are each configured to receive fuel vented by two of PRDs 88, and vent tubes 120b are each configured to receive fuel vented by four of the PRDs.

In fuel system 80b, PRDs 88 can be coupled in fluid communication with fuel tanks 84 via conduits 124a. And this coupling can be such that, for each of fuel tanks 84, for each of PRDs 88, fuel is permitted to flow from the fuel tank to the PRD. In other words, each of PRDs 88 can be in fluid communication with each of tanks 84. In at least this way, fuel system 80b provides for increased flexibility in where the PRDs can be mounted. To illustrate, in fuel system 80b, none of PRDs 88 are mounted (e.g., including via one or more fittings, valves, and/or the like) to outlet 82 of any of fuel tanks 84. Leveraging this flexibility, PRDs 88 can be positioned in the fuel system 80b at various locations that render them—individually and collectively—more responsive to events (e.g., fires) and thereby safer. In fuel system 80b, for example, PRDs 88 are positioned between adjacent ones of fuel tanks 84 in a direction that is transverse to those fuel tanks, which includes whether they are above, below, or in-line with those fuel tanks. To be clear, however, in some of the present fuel systems, one or more PRDs (e.g., 88) can be mounted to an outlet (e.g., 82) of a fuel tank (e.g., 84).

As shown, via conduits 124a, fuel flow between each of fuel tanks 84 and each of PRDs 88 is permitted without requiring the fuel to flow through a valve that is not one of the PRDs. In this way, the PRDs' reliability is enhanced: there is not an intervening non-PRD valve that could otherwise frustrate operation of the PRDs. Further, for at least one of PRDs 88, fuel is permitted to flow from each of fuel tanks 84 and to the PRD without flowing through another one of the PRDs, which enhances the reliability of that particular PRD, given that it can thus operate to vent fuel from the fuel tanks independently of any other of the PRDs.

The above-described connections between fuel tanks 84 and PRDs 88 can be facilitated by one or more of the present fuel tank fittings, with, for example, a fuel tank fitting (e.g., 10) coupled to necks 82 of each of fuel tanks 84, but such fuel tank fittings are not required. As with others of the present fuel systems (e.g., 80), fuel system 80b can be installed on a vehicle having an engine (e.g., 98), where the fuel system comprises a shut-off valve (e.g., 92) configured to control the flow of fuel from the fuel tanks to the engine. In such a configuration, the fuel conduits (e.g., 124a) can couple the fuel tanks to the engine such that, for each of the fuel tanks, fuel is permitted to flow from the fuel tank to the shut-off valve without flowing through a valve that is not one of the PRDs.

Some of the present methods comprise flowing fuel from two or more fuel tanks (e.g., 84) of a vehicle (e.g., 90a) to two or more PRDs (e.g., 88) of the vehicle that are configured to vent the fuel in response to temperature, wherein the fuel tanks are coupled in fluid communication with the PRDs such that, for each of the fuel tanks, for each of the PRDs, fuel is permitted to flow from the fuel tank to the PRD without flowing through a valve that is not one of the PRDs.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A fuel system comprising:
two or more fuel tanks, each containing fuel at a pressure of between 3,000 pounds per square inch (“psi”) and 12,000 psi;
two or more pressure-relief devices (“PRDs”) configured to receive fuel from the fuel tanks and vent the received fuel in response to temperature; and
fuel conduits coupling the fuel tanks to the PRDs such that, for each of the fuel tanks, for each of the PRDs, fuel is permitted to flow from the fuel tank to the PRD without flowing through a valve that is not one of the PRDs.

2. The fuel system of claim 1, wherein the fuel conduits couple the fuel tanks to the PRDs such that, for each of the fuel tanks, for at least one of the PRDs, fuel is permitted to flow from the fuel tank to the PRD without flowing through another one of the PRDs.

3. The fuel system of claim 1, wherein:
each of the fuel tanks comprises an outlet through which fuel is permitted to exit the fuel tank; and
none of the PRDs are mounted to the outlet of any of the fuel tanks.

4. The fuel system of claim 1, wherein at least one of the PRDs is configured to vent the received fuel upon reaching a temperature that is between approximately 100° C. and approximately 120° C.

5. The fuel system of claim 1, comprising a vent tube configured to receive fuel that is vented by at least one of the PRDs.

6. The fuel system of claim 1, wherein the fuel tanks comprise three or more fuel tanks.

7. The fuel system of claim 1, wherein the PRDs comprise four or more PRDs.

8. The fuel system of claim 1, wherein:
the fuel system is installed on a vehicle having an engine and comprises a shut-off valve configured to control the flow of fuel from the fuel tanks to the engine; and
the fuel conduits couple the fuel tanks to the shut-off valve such that, for each of the fuel tanks, fuel is permitted to flow from the fuel tank to the shut-off valve without flowing through a valve that is not one of the PRDs.

9. The fuel system of claim 1, wherein the fuel comprises compressed natural gas (“CNG”) or hydrogen.

10. A method comprising:
flowing fuel from two or more fuel tanks of a vehicle to two more PRDs of the vehicle that are configured to vent the fuel in response to temperature;
wherein the fuel tanks are coupled in fluid communication with the PRDs such that, for each of the fuel tanks, for each of the PRDs, fuel is permitted to flow from the fuel tank to the PRD without flowing through a valve that is not one of the PRDs; and
wherein the fuel is at a pressure of between 3,000 psi and 12,000 psi.

11. The method of claim 10, wherein the fuel tanks are coupled in fluid communication with the PRDs such that, for each of the fuel tanks, for at least one of the PRDs, fuel is permitted to flow from the fuel tank to the PRD without flowing through another one of the PRDs.

12. The method of claim 10, wherein:
each of the fuel tanks comprises an outlet through which fuel exits the fuel tank; and
none of the PRDs are mounted to the outlet of any of the fuel tanks.

13. The method of claim 10, wherein at least one of the PRDs is configured to vent the fuel upon reaching a temperature that is between approximately 100° C. and approximately 120° C.

14. The method of claim 10, wherein the vehicle comprises a vent tube configured to receive fuel that is vented by at least one of the PRDs.

15. The method of claim 10, wherein the fuel tanks comprise three or more fuel tanks.

16. The method of claim 10, wherein the PRDs comprise four or more PRDs.

17. The method of claim 10, wherein:
the vehicle comprises an engine and a shut-off valve configured to control the flow of fuel from the fuel tanks to the engine; and
the fuel tanks are coupled in fluid communication with the shut-off valve such that, for each of the fuel tanks, fuel is permitted to flow from the fuel tank to the shut-off valve without flowing through a valve that is not one of the PRDs.

18. The method of claim 10, wherein the fuel comprises CNG or hydrogen.
